(19) United States
(12) Patent Application Publication
(10) Pub. No.: US 2019/0133345 A1
(43) Pub. Date: May 9, 2019

(54) Interactive Mirror Device

(71) Applicant: Scale Development LLC, New York, NY (US)

(72) Inventor: Kurt Franz, Brooklyn, NY (US)

(73) Assignee: Scale Development LLC, New York, NY (US)

(21) Appl. No.: 16/184,893

(22) Filed: Nov. 8, 2018

Related U.S. Application Data
(60) Provisional application No. 62/583,028, filed on Nov. 8, 2017.

(51) Int. Cl. A47G 1/02; H04L 12/24; G06F 3/041; G06F 17/30; A47B 67/00

(52) U.S. Cl. CPC A47G 1/02; H04L 41/0883; H04L 41/0806; H04L 67/12; G06F 17/30867; A47B 67/005; G06F 3/0412

(57) ABSTRACT

Methods, systems and apparatuses, including computer programs encoded on computer storage media, are provided for an interactive mirror device. The interactive mirror device comprises a mirror, a display mounted behind the mirror, a processor, a memory including a mirror application, one or more user inputs, and one or more communication modules. The interactive mirror may be in communication with one or more devices and/or services, from which the mirror may receive various types of information. The information may be displayed or otherwise communicated to a user. The interactive mirror may also aggregate and display the information into a form more useful to the user, based on settings or other input from the user. The interactive mirror may replace a mirror door of an existing medicine cabinet, may be installed next to, and physically connected with, an existing medicine cabinet, or may be surface mounted to a wall or recessed into a wall.

### CROSS-REFERENCE TO RELATED APPLICATIONS

The present application claims benefit of U.S. provisional patent application Ser. No. 62/583,028 titled “Interactive Mirror Device,” filed Nov. 8, 2017, which is incorporated by reference herein in its entirety.

### BACKGROUND

This specification relates generally to interactive mirror devices that connect to a variety of systems and devices in order to receive information therefrom and provide relevant content to users.

Mirrors are an integral aspect in the lives of many people. For example, mirrors are commonly used for personal grooming, decoration, and architecture in homes throughout the world. Given the ubiquity of mirrors and their prominent placement in residencies, it is no wonder that a number of so-called “smart mirrors” have started to appear on the market. Unfortunately, available smart mirrors do not aggregate information from multiple devices and systems to provide curated content and suggestions to users. Moreover, these smart mirrors are not designed to be mounted adjacent to traditional mirrors or mirrored cabinets, nor are they adapted to replace the mirror of a mirrored cabinet.

Accordingly, there remains a need for interactive mirror devices that connect to a variety of systems and devices in order to receive information therefrom and provide curated content and/or suggestions specific to one or more users. It would be beneficial if the interactive mirror devices were capable of being installed in a wide variety of configurations, including being mounted directly to a mirrored cabinet and/or adjacent to such cabinets.

### SUMMARY

In accordance with the foregoing objectives and others, exemplary interactive mirror devices and systems that include such devices are disclosed herein. Embodiments of the interactive mirror device may be placed in communication with any number of systems and devices in order to transmit and/or receive information to/from such systems and devices. The disclosed mirror devices may be further adapted to determine and display curated content and/or suggestions to users based on received information, for example, via an included screening displaying a graphical user interface (“GUI”). The described embodiments may be attached to a traditional cabinet or may be mounted to, or within, a wall.

In one embodiment, a system is provided. The system may include a server storing user information with a user and a mirror device in communication with the server via a network. In The mirror device may include a housing made of a front panel including an aperture therein; a back panel having an input port located therein; and left, right, top, and bottom panels extending from the front panel to the back panel to define an inner chamber. The mirror device may also include electronic components disposed within the inner chamber of the housing. Such electronic components may include a network interface receiving the user information from the server via the network; a memory storing the received user information; an input device receiving a user request from the user; a processor in communication with the memory, the input the device, and the network interface; and a display in communication with the processor. In certain embodiments, the processor may determine a recommendation for the user based on the user information and the user request, and the display may display the determined recommendation. The mirror device may further include a mirror having a front surface, a back surface attached to the front panel of the housing, and top, bottom, left and right surfaces extending form the front surface to the back surface.

In certain embodiments, the above system may also include an external module. The external module may have an input power port located on an outer surface thereof, wherein the input power port may be in electrical communication with a power source. The module may also include an output power port located on the outer surface, wherein the output power port may be in electrical communication with the input port of the mirror device. It will be appreciated that the external module may be seated within an interior of the cabinet and, optionally, may be attached to an interior surface of the cabinet.

In some cases, the mirror device of the above system may be attached to a cabinet having an open front face. The back panel of the housing of the mirror device may entirely cover the open front face of the cabinet when the mirror device is in a first position (e.g., a closed position). And the back panel may not entirely cover the open front face of the cabinet when the mirror device is in a second position (e.g. an open position).

In another embodiment, an interactive mirror device is provided. The mirror device may include a housing with a front panel having an aperture therein; a back panel; and left, right, top, and bottom panels extending from the front panel to the back panel to define an inner chamber of the housing. The mirror device may also include a plurality of electronic components disposed within the inner chamber of the housing. Exemplary electronic components include: a processor in communication with one or more of: a memory, an input device, an output device, a network interface and/or a display that includes a screen. The display may be positioned within the inner chamber of the housing such that the screen faces the front panel of the housing and substantially covers the aperture in the front panel. The mirror device may also include a mirror having a front surface connected to a back surface by top, bottom, left and right surface. The back surface of the mirror may be attached to the front panel of the housing such that the back surface of the mirror completely covers the front panel of the housing and the screen of the display. Such mirror device may be configured to allow images displayed on the screen to show through the front surface of the mirror when the display is on. And the mirror device may prevent the screen from being seen through the front surface of the mirror when the display is off.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an exemplary system 100 according to an embodiment.

FIG. 2A shows an exemplary mirror device 210 comprising a mirror 204 attached to a housing 232 according to an embodiment.

FIG. 2B shows a rear view of the mirror 204 of the mirror device 210 according to an embodiment.

FIG. 2C shows a front view of a housing 232 of the mirror device 210 according to an embodiment.

FIG. 2D shows the mirror device 210 attached to a traditional cabinet 250 according to an embodiment.

FIG. 3 shows an exemplary mirror device 310 attached to a traditional cabinet 350 in accordance with an embodiment, wherein the device further comprises an external module 360.

FIGS. 4A-B show an exemplary mirror device 410 and a connection means for mounting the device adjacent to a traditional mirrored cabinet 450 according to an embodiment.

FIG. 5 shows exemplary electronic components an interactive mirror device 510 according to an embodiment.

FIG. 6 shows an exemplary dashboard screen 600 of a mirror application displayed on a display 608 of an interactive mirror device 610 according to an embodiment.

FIG. 7 shows an exemplary app screen 700 displayed on a display 708 of an interactive mirror device 710 according to an embodiment.

### DETAILED DESCRIPTION

Various interactive mirror devices that connect to, and receive information from, any number of devices are disclosed. The described embodiments may be attached to a traditional cabinet or may be mounted to, or within, a wall.

The interactive mirror devices of the present disclosure may be configured in one of two primary embodiments—a mirror with casement embodiment and a mirror without casement embodiment (i.e., a “mirror-only” embodiment). The mirror with casement embodiment may include a number of electronic components, including but not limited to, a display, a processor, memory, a communication module, one or more input devices (e.g., a touchscreen input, a camera or other gesture recognition module, a microphone or other voice recognition module, etc.) and/or one or more output devices (e.g., speakers, lights, vibration motors, etc.). Such electronic components may be housed behind the mirror, in a housing or casement. The interactive mirror device may be similar in size and/or shape to traditional mirrored cabinets (e.g., medicine cabinets) and may be connectable thereto (e.g., via a connection means located on a side of the casement). Accordingly, the interactive mirror device of this embodiment may be surface mounted on a wall or may be recess mounted within a wall.

The mirror-only embodiment of the interactive mirror device may include electrical components, such as but not limited to, a display, a processor, memory, a communication module, and one or more of the above-listed input and output devices. Such electrical components may be seated behind the mirror, within a thin housing that includes hinges to enable the interactive mirror device to connect to a traditional cabinet. Accordingly, the interactive mirror of this embodiment may be surface mounted on a wall, recess mounted within a wall and/or may be connected to a cabinet that may itself be surface mounted to, or recesses mounted within, a wall.

Both embodiments of the interactive mirror device may include a processor that executes a software application (a “mirror application”) to enable users to connect the interactive mirror device to any number of additional devices, such as but not limited to, so-called “Internet of Things” devices (“IoT devices”). The mirror application may also enable users to connect the interactive mirror to various third-party systems and services relating to, for example, weather, news, calendaring, sports, maps, traffic and navigation, social media and others.

The mirror application may display or otherwise transmit any information received from connected devices, systems, applications and services (individually and collectively referred to hereafter as “devices” for convenience) to a user via a display or other output device of the interactive mirror. In certain embodiments, the mirror application may aggregate received information into results of higher relevance to a user and may determine suggestions for the user (e.g., based on determined user activity patterns). The mirror application may employ machine learning functionality to automatically and continually update displayed information and/or suggestions. To that end, the described applications and systems may store, retrieve, and/or analyze user data from internal and connected systems using a machine learning engine. The mirror application may also control connected devices based on user input, on a scheduled basis and/or in response to one or more notifications from a connected device.

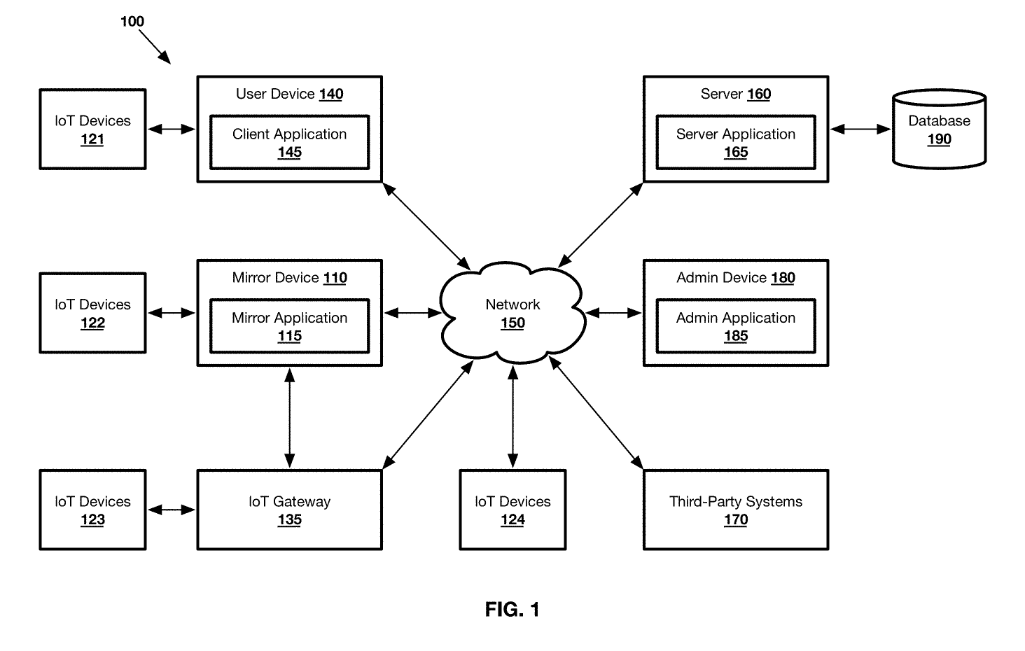

Referring to FIG. 1, a block diagram showing various components of an exemplary system 100 according to an embodiment is illustrated. As shown, the system 100 comprises an interactive mirror device 110 in communication with one or more of: a network 150, a server 160, user or client devices 140, admin devices 180, IoT devices (121, 122, 123 and 124), an IoT gateway 135 and/or various third-party systems 170.

Generally, the interactive mirror device 110 may comprise a processor that executes a mirror application 115. Similarly, each of the server 160, the client devices 140, and the admin devices 180 includes a processor that executes a server application 165, a client application 145, and an admin application 185, respectively. The various applications disclosed herein may each comprise one or more computer programs, software, or other computer code or instructions.

The mirror device 110 may be in direct or indirect communication with one or more IoT devices (121, 122, 123 and 124). Generally, each of the connected IoT devices (121, 122, 123 and 124) may transmit and/or receive device information to/from the interactive mirror device 110. Exemplary IoT devices may include, but are not limited to: health devices, home automation devices, environmental sensing devices and others.

Health devices may include any device that measures, determines and/or provides notifications relating to a user's health information. Health information may relate to, for example, physical activities (e.g., walking, working out, sitting, standing, traveling from one location to another, etc.), sleep and/or meditation, medical information (e.g., blood pressure, heart rate, body temperature, weight, age, physical appearance, etc.), nutritional information (e.g., caloric intake, water intake, specific foods eaten, medication taken, etc.) and/or others. Accordingly, exemplary health devices may include, but are not limited to, wearable devices (e.g., watches, bracelets, rings, clothing, sweatbands, shoes), scales, water bottles, pill bottles, mattresses, toothbrushes, medical equipment, medical testing kits, location tracking devices and/or others.

Home automation devices may include any device that measures, determines, controls and/or provides notifications relating to mechanical, electrical and electronic systems used in various types of buildings (i.e., “home automation information”). Exemplary home automation devices may include, but are not limited to, smart hubs, speakers, televisions, cameras, security alarms, smoke detectors, gas detectors, locks, motion sensors, toasters, ovens, refrigerators, trash cans, air conditioners, thermostats, humidifiers, dehumidifiers, air purifiers, window shades, light bulbs, vacuums, alarm clocks, plant monitoring devices, baby monitors, pet feeders, and/or others. And exemplary home automation information relating to such devices may include lighting information, appliance information, sensor information, alarm or lock status, security camera feed, motion detector information

Environmental sensing devices may include any device that measures, determines, controls and/or provides notifications relating to environmental information (e.g., temperature, humidity, weather, pressure, gravity, etc.). Accordingly exemplary environment sensing devices include temperature sensors, humidity sensors, atmospheric pressure sensors, water sensors, and others.

Other exemplary IoT devices may measure, determine, control and/or provide notifications relating to: location and/or navigation information (e.g., locations of various people and objects, traffic information, commute information, etc.); news information; social media information (e.g., status updates, check-ins, comments, likes, friend requests, etc.); entertainment information (e.g., information relating to TV, movies, music, tickets, events, etc.); status information (e.g., battery status, connection quality, etc.) and/or any others.

The interactive mirror device 110 may communicate with IoT devices (121, 122, 123 and 124) via any number of direct or indirect connections. In one embodiment, the interactive mirror device 110 may communicate with one or more IoT devices 124 through a network 150, such as the Internet, a local area network (“LAN”), a cellular network, a wide area network (“WAN”), an intranet, etc. In such embodiments, device information may be transmitted from an IoT device 124 to the server 160 via the network 150, and such information may be transmitted from the server 160 to the interactive mirror device 110.

In another embodiment, the interactive mirror device 110 may directly communication with one or more IoT devices 122 that are enabled to use one or more of the communication protocols used by the interactive mirror device. For example, an IoT device 122 may be plugged into a Universal Serial Bus (“USB”) port of the interactive mirror device 110 or may communicate wirelessly with the interactive mirror device via a Bluetooth or Near-Field Communication (“NFC”) connection.

In yet another embodiment, the interactive mirror device 110 may communicate with one or more IoT devices 123 via a user device 140. For example, an IoT device 123 may be physically connected to a user device 140 via a USB or Apple LIGHTNING connection and/or may be connected wirelessly to the user device via a Bluetooth or NFC connection. In such cases, any device information received from an IoT device 123 by the user device 140 may be transmitted directly to the mirror device 110 and/or may be transmitted indirectly thereto (e.g., via the network 150 and/or the server 160).

In one particular embodiment, the interactive mirror device 110 may communicate with one or more IoT devices 121 through one or more internal or external IoT gateways 135. Generally, an IoT gateway 135 may comprise a communications module adapted to transmit and/or receive device information to/from IoT devices 121 via one or more communication protocols, including but not limited to Bluetooth Low Energy (“BLE”), NFC, radio-frequency identification (“RFID”), ZIGBEE, ZWAVE, or cellular link (e.g., CDMA or GSM). And each gateway 135 may transmit and/or receive device information to/from the interactive mirror device 110 and/or the server 160 via Wi-Fi or Ethernet.

For example, certain IoT devices 121 may not be able to communicate directly with the interactive mirror 110 or the server 160 via a Wi-Fi or Ethernet connection. Rather, such devices may require less ubiquitous and/or proprietary connections (e.g., a low-rate wireless personal area network (“LR-WPAN”) such as ISA100.11a, WIRELESSHART, MIWI, ZWAVE, SNAP, THREAD or ZIGBEE). In such instances, the IoT device(s) 121 may communicate directly with the gateway 135 and the gateway may communicate with the interactive mirror 110 and/or the server 160 via a Wi-Fi or Ethernet connection.

In certain embodiments, users can configure a connection between the interactive mirror device 110 and IoT devices (121, 122, 123 and 124) using a mirror application 115. The mirror device may automatically detect IoT devices and/or IoT gateways 135 (e.g., through device discovery) and may prompt users to enable the connection via the mirror application 115 shown on a display of the mirror device.

Alternatively, the system may require a user to provide initial configuration information in order to connect certain IoT devices (121, 122, 123 and 124). For example, a user may be required to provide device routing information in order for the system to locate a given IoT device and/or to input user account information in order to associate such devices with the user's account. Upon receiving any required configuration information, the system may store the information and use it to automatically connect to one or more IoT devices in the future.

In certain embodiments, configuration information may need to be transmitted to an IoT device (121, 122, 123 and 124) in order to connect it to the system. For example, an IoT device may require a user to provide routing information for the interactive mirror device 110 before a connection may be established. As another example, an IoT device may require a user to set update intervals and/or privacy information before the IoT device may communicate with the interactive mirror device. It will be appreciated that, after the user provides initial configuration information to the IoT device to establish a connection with the interactive mirror device 110, they may update the configuration information via the mirror application 115 or a separate client application 145 (discussed below). Similarly, an admin user may set or update such configuration information via an admin application 185 running on an admin device 180.

The interactive mirror device 110 will typically be in communication (e.g., via network 150) with a server 160 running a server application 165. As shown, the server may be in communication with one or more databases 190 via a network 150 or another wired or wireless connection. Although shown as external to the server 160, it will be appreciated that the database 190 may be integral thereto. The server may store desired or required information in the database and may access the same to retrieve the information.

The server 160 may be adapted to receive, determine, record and/or transmit device information relating to any number of IoT devices (121, 122, 123 and 124) and/or user information relating to any number of users. Such information may be manually entered or selected by a user via mirror application 115 or client application 145. Such information may also be automatically received or determined from any number of interactive mirror devices 110, user devices 140, admin devices 180, IoT devices (121, 122, 123 and 124) and/or third-party systems 170. And the server 160 may store received or determined information in, for example, the database 190.

Generally, user information may include, but is not limited to: user identification information (e.g., name, age, date of birth, sex, social security number, photo, etc.); contact information (e.g., email address, mailing address, phone number, social media or other messaging accounts, etc.); billing information (e.g., credit card information, billing address, etc.); and account information (e.g., unique user ID, a group or organization with which the user is associated, username, password, etc.). The user information stored on the server may also include information relating to one or more mirror devices associated with the user (e.g., MAC address, unique mirror device ID, a group or organization with which the device is associated, etc.) one or more user devices associated with the user (e.g., unique user device ID, user device type, etc.); and/or notification preferences. And the stored account information may be used to access one or more accounts associated with connected IoT devices.

While only one interactive mirror device 110 is shown in FIG. 1, it will be appreciated that any number of such devices may be in communication with the server 160. In certain embodiments, the server 160 may be configured to send notifications to one or more interactive mirror devices 110. For example, a system for an apartment complex (or even multiple apartment complexes) may include one or more mirror devices 110 in each apartment. If management wants to send a notification to each apartment, the notification information can be entered into an admin application 185 of an admin device 180 and sent to the server 160. Upon receiving the information, the server 160 may broadcast the notification to one or more interactive mirror devices 110 and/or one or more user devices 140 associated with such mirror devices. The notification can be sent to all connected mirror devices or only to select devices based on any of the user information stored by the server. In certain embodiments, management (or other admin users) may remotely manage any software installed on the various mirror devices 110 via a similar process.

As shown, the server 160 and/or the interactive mirror device 110 may be in communication with one or more user or client devices 140, wherein each user device is adapted to access or execute a client application 145. In certain embodiments, a user may access the server 160 (i.e., a server application 165 running on the server) and/or the interactive mirror device 110 (i.e., a mirror application 115 running on the interactive mirror device) through a user device 140 connected to a network 150.

A user device 140 may be any device capable of accessing the server 160 and/or interactive mirror device 110 such as by running a client application 145 or other software, like a web browser or web-browser-like application. In one embodiment, a user device 140 may comprise, for example, a processor, memory, a display and any number of input/output devices. Exemplary user devices 140 include, but are not limited to, general purpose computers, laptops, smartphones, tablets, wearable devices and the like.

A user device 140 may be used to configure and control certain aspects of the interactive mirror device 110 and/or the mirror application 115. A user device 140 may also be used to engage in communication with the server 160 (e.g., via a web-based or native client application 145). For example, a client application 145 may make a request for a specific resource using HTTP/HTTPS and the server 160 may respond with the content of that resource or an error message if unable to do so. The resource may be data or a file stored in a database 190.

It will be apparent to one of ordinary skill in the art that, in certain embodiments, any of the functionality of the user device 140 and/or interactive mirror device 110 may be incorporated into the server 160, and vice versa. Likewise, any functionality of a mirror application 115 and/or client application 145 may be incorporated into a browser-based client, and such embodiments are intended to be fully within the scope of the embodiments. For example, a client application 145 or mirror application 115 could be configured for offline work by adding local storage capability, and a native application could be distributed for various native platforms via software layer which executes the browser-based program on the native platform.

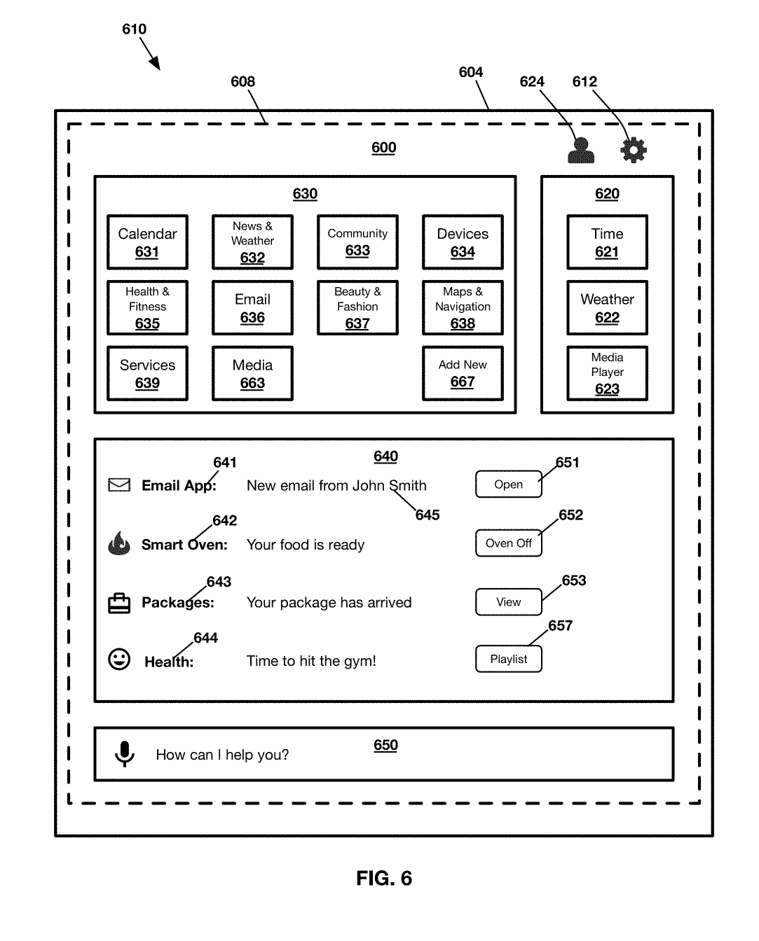

In certain embodiments, the interactive mirror system 100 may include one or more third-party systems 170, which may communicate with the server 160, the interactive mirror device 110, the user devices 140, and/or other system components via the network 150. The third-party systems 170 may provide an application programming interface (“API”), through which the server 160 and/or interactive mirror device 110 may send and/or receive device information and user information. Moreover, as discussed below in reference to FIG. 6, third-party systems 170 may provide third-party applications and widgets that may be downloaded to the interactive mirror device 110 and/or user devices 140.

Exemplary third-party systems include, but are not limited to: news services, sports services, weather services, calendar services, email services, phone services, social media and chat services, music services, video services, photo services, e-commerce products and services, navigation and mapping services, travel services (cars, busses, planes, trains, bikes, etc.), shopping list services, to-do list services, local-event services, fitness services, logistics services (e.g., shipping services, scheduling services, etc.), food services (e.g., delivery, reservations, etc.), and user review services (e.g., YELP). The mirror application may be configured to enable a user to select third-party services from/to which the mirror application will receive/transmit data.

The system may also include one or more admin devices 180, running an admin application 185. The admin application 185 may be configured to allow an admin user to create, update and/or delete user information, device information and/or configuration information associated with any number of user accounts. Additionally, the admin application 185 may allow admin users to create, update and/or delete various system software and/or applications and widgets associated with one or more user accounts.

An admin device 180 may be any device capable of accessing the server 160 and/or interactive mirror device 110 such as by running an admin application 185 or other software, like a web browser or web-browser-like application. In one embodiment, an admin device may comprise, for example, a processor, memory, a display, and any number of an input/output devices. Exemplary admin devices include, but are not limited to, general purpose computers, laptops, smartphones, tablets, wearable devices and the like.

It will be appreciated that any information received by the interactive mirror device 110 or the server 160 may be displayed to a user and/or may be used to calculate additional information, such as recommendations. Exemplary calculated information may include, but is not limited to, commute information (e.g., suggested routes, which may be determined in part using current traffic information, a current location, and a stored “work” location); suggested health information (e.g., workout time, workout routine, workout intensity, water consumption, etc., which may be determined in part using past activity information, health information, and water and/or food consumption information); suggested entertainment information (e.g., a music or video playlist for a scheduled or suggested activity); suggested locations and events (e.g., suggested restaurants, which may be based in part on previous restaurants visited by the user, user financial information, and/or user reviews); and/or suggested purchases, which may be based on prior purchases.

It will be further appreciated that device information, calculated information and/or user information may be displayed automatically (e.g., continuously or at predefined intervals) or in response to a query from a user of the interactive mirror device 110. Additionally or alternatively, such information may be transmitted from the interactive mirror device to a user device 140, admin device 180 and/or any IoT device 120, based on configuration options set by the user.

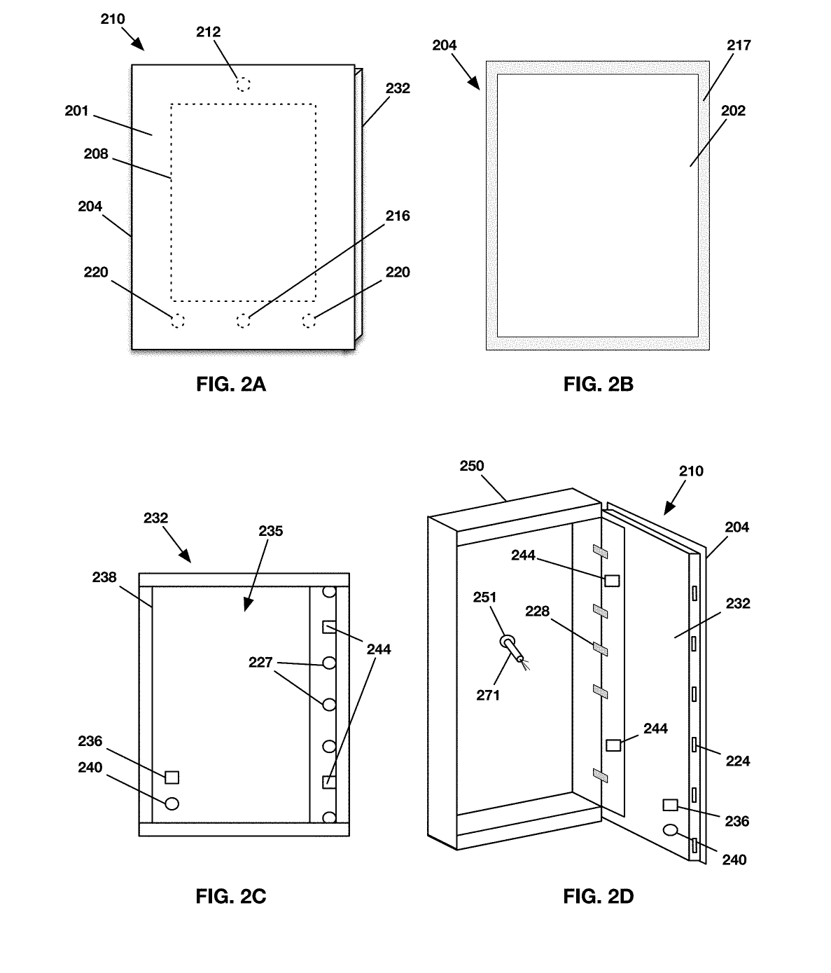

Referring to FIGS. 2A-D, exemplary views of an interactive mirror device 210 are illustrated. FIG. 2A shows a front perspective view of an exemplary mirror device 210 comprising a mirror 204 attached to a housing 232 that has a number of electronic components seated therein, such as a display 208, cameras 212, speakers 220, and microphones 216. FIG. 2B shows a rear view of the mirror 204. FIG. 2C shows a front view of the housing 232. And FIG. 2D shows the mirror device 210 attached to a traditional cabinet 250 via a number of hinges 228.

As shown, in one embodiment, the interactive mirror device 210 may generally be sized and/or shaped to replace a traditional mirror of a mirrored cabinet. To that end, the mirror device 210 (and the mirror 204 of the device) may comprise a width of from about 10 inches to about 40 inches, and a height of from about 25 inches to about 50 inches. For example, the mirror device 210 may comprise dimensions selected from the group consisting of: a height of about 30 inches and a width of about 12 inches; a height of about 30 inches and a width of about 15 inches; a height of about 30 inches and a width of about 20 inches; a height of about 30 inches and a width of about 24 inches; a height of about 30 inches and a width of about 30 inches; a height of about 30 inches and a width of about 34 inches; a height of about 30 inches and a width of about 40 inches; a height of about 39 inches and a width of about 39 inches; and a height of about 40 inches and a width of about 12 inches.

The interactive mirror device 210 may generally comprise any depth or thickness (defined by the combined thickness of the mirror 204 and the housing 232), as long as it is capable of being mounted to a traditional cabinet 250. In certain embodiments the interactive mirror device 210 may comprise a thickness of from about 0.1 inches to about 8 inches, and more specifically from about 0.5 inches to about 5 inches. In one embodiment, the mirror device comprises a thickness of less than or equal to about 1 inch.

The mirror 204 of the device 210 typically comprises a rectangular or square shape, as discussed above. The mirror 204 comprises a substantially flat front surface 201 and a substantially flat back surface 202, wherein the front and back surfaces are connected by substantially flat top, bottom and side surfaces. In certain embodiments, the mirror 204 may comprise a thickness (defined as the distance between its front 201 and back 202 surfaces) of from about 0.05 inches to about 1 inch (e.g., about 0.125 inches, about 0.25 inches, about 0.375 inches, about 0.5 inches, about 0.625 inches, about 0.75 inches, about 0.875 inches or about 1 inch).

The mirror 204 is generally adapted to allow images displayed on a display 208 to show through the mirror's front surface 201 when the display is on, while preventing the display 208 from being seen through the front surface when the display is off. Accordingly, the mirror 204 typically comprises a thin pane of suitable glass, such as low-iron glass. Although less preferred, an acrylic material may be used in place of glass in certain embodiments.

In some embodiments, the front 201 and/or back 202 surfaces of the mirror glass may be coated with one or more materials, applied in one or more layers. Exemplary coatings include, but are not limited to, reflective coatings (e.g., tin chloride, silver, gold, copper, aluminum, etc.); dielectric coatings (e.g., magnesium fluoride, calcium fluoride, silicon oxides, silicon nitrides, and/or other metal oxides); transparent conductive coatings (e.g., indium tin oxide (“ITO”), aluminium-doped zinc oxide (“AZO”), etc.); anti-fingerprint oleophobic coatings; anti-fog coatings; anti-bacterial coatings and/or other coatings.

As shown in FIG. 2B, the back surface 202 of the mirror 204 may include an aluminum strip 217 adhered to one or more edges thereof (e.g., via an adhesive material). Such aluminum strip 217 may be included to allow for improved venting of heat from inside the housing 232 (with or without use of a fan), to provide for an improved connection between the mirror 204 and the housing 232, and/or to allow for improved handling of the mirror 204 during assembly of the mirror device 210.

As shown in FIG. 2C, the housing 232 of the mirror device 210 may comprise a substantially open front surface 235 and substantially flat left, right, top, bottom and back surfaces. The left, right, top, bottom and back surfaces of the housing may be substantially closed (other than the vents 224 and/or ports 244, 236) to prevent ambient light from entering the housing. This may prevent electronic components disposed within the housing from being seen through a front surface of the mirror 204 when the display 208 is off.

In one embodiment, the open front surface 235 of the housing 232 may include a rim 238 that extends a distance inward from the outer edges of the housing. That is, the front surface 235 may comprise an aperture having a size/shape that is about equal to the size/shape of the display 208 (i.e., a screen of a display). Accordingly, the front surface 235 may be substantially covered when the display 208 is disposed within the housing and/or when the mirror 204 is attached to the housing 232.

In certain embodiments, the housing 232 may optionally include one or more vents 224 to allow heated air to escape from inside the housing (with or without the use of a fan). The housing 232 may further comprise one or more hinge holes 227 to which hinges 228 may be affixed to allow the mirror device 210 to be attached to a traditional cabinet 250, for example, by removing a traditional mirror or cabinet door from the cabinet and installing the mirror device in its place.

The housing 232 generally comprises a height and width that are less than or equal to the height and width of the mirror 204. For example, the housing may comprise a height that is equal to about 60 percent to about 98 percent of the height of the mirror 204 (e.g., about 75 percent to about 95 percent); and a width that is equal to about 60 percent to about 98 percent of the width of the mirror (e.g., about 75 percent to about 95 percent). Moreover, the housing typically comprises a thickness of from about 0.25 inches to about 5 inches (e.g., about 0.25 inches, about 0.5 inches, about 0.75 inches, about 1 inch, about 1.25 inches, about 1.5 inches, etc.). In one particular embodiment, the housing comprises a thickness of less than or equal to about 1 inch.

The housing 232 may comprise any materials that allow the housing to: (1) support the mirror 204 and display 208, (2) protect the electronic components disposed within the housing from moisture and dust, and/or (3) be mounted to a cabinet 250. In certain embodiments, the housing 232 may be waterproof and may comprise one or more materials selected from the group consisting of: wood, metal, and/or plastic.

The display 208 of the mirror device 210 may comprise any size and/or shape, as long as its perimeter is smaller than the mirror 204 and it is thin enough to fit within the housing 232. Generally, the display 208 may be placed in any configuration with respect to the mirror, such as centered or to one side. The location of the display may be based on factors such as installation location, ability of the user to reach the display comfortably and/or aesthetics.

The display 208 typically comprises a touchscreen, such as but not limited to, projected capacitive touch (“PCAP” or “PCT”), resistive touch, surface acoustic wave touch (“SAW”), infrared (“IR”) touch and other touchscreens. In one preferred embodiment, a PCAP touchscreen is used. A PCAP screen comprises an insulator (e.g., glass) coated with a matrix of rows and columns of a transparent conductive material (e.g., ITO). When a voltage is applied to the matrix, it creates an electrostatic field on the surface of the conductor. If an electrical conductor, such as a human finger, touches the display, the electrostatic field is distorted and this distortion may be detected by the display. One benefit of PCAP is that it enables a multi-touch capability (i.e., the touchscreen can simultaneously detect multiple touch points).

In certain embodiments, the mirror device 210 may include one or more input devices (e.g., cameras 212 and microphones 216) and one or more output devices (e.g., speakers 220) to enable user interaction. For example, a camera 212 may allow for gesture recognition functionality and a microphone 216 may allow for voice activation and/or speech recognition functionality. As another example, one or more speakers 220 may allow for audio playback functionality.

The mirror device 210 may include one or more power/Ethernet ports 244 to connect to a power source and/or Ethernet source, one or more input/output ports 236 (e.g., USB, HDMI, headphone, etc.) and/or a power/reset button 240. Such components may be located within one or more surfaces of the housing 232. In one embodiment, a power/Ethernet cable 271 may be connected to the power/Ethernet port 244 by running the cable through an aperture 251 in a cabinet 250 to which the mirror device 210 is attached.

While various elements are shown in particular locations in FIGS. 2A-2D, these elements may also be disposed in other locations. For example, a camera 212, microphone 216 and/or speakers 220 may be located anywhere around the display 208, as appropriate for a particular implementation. As another example, the vent 224, hinges 228, power port 244, input/output ports 236, and/or power/reset button 240 may be located anywhere along a surface of the housing 232 (e.g., on a top, bottom, side or back surface).

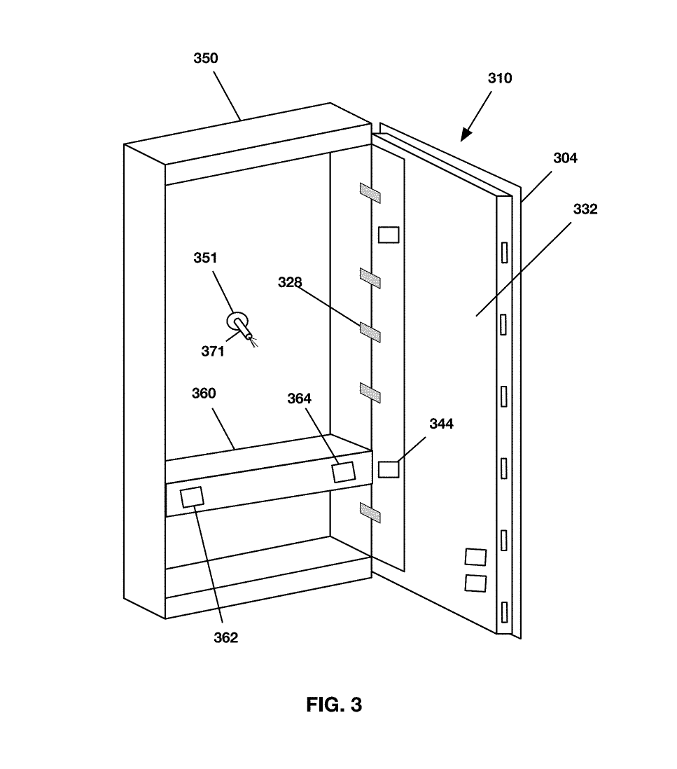

Referring to FIG. 3, an alternative embodiment of a mirror device 310 is illustrated, wherein the device further comprises an external module 360 that may be seated within a traditional cabinet 350. As shown, the external module 360 comprises an outer surface having a number of ports therein, such as one or more input ports 362 and one or more output ports 364. The outer surface of the module 360 may define an interior chamber for holding some electronic components and such components may be placed in electrical communication with the electronic components seated within the housing 332 of the mirror device.

In one embodiment, the external module 360 may include power circuitry and/or networking circuitry seated within its interior compartment. In such cases, a power/Ethernet cable 371 may connect a power source to the input port 362 of the external module 360. A second cable (not shown) may then connect the output port 364 of the external module 360 to a power/Ethernet input port 344 of the mirror device housing 332 to place the electronic components in the module and housing in electrical communication. As shown, the first cable 351 may extend through an aperture 351 in the cabinet 530 to which the external module 360 and mirror device 310 are attached.

Generally, the external module 360 may be shaped/sized such that it fits within a traditional cabinet 350 and such that it includes an interior compartment to hold some of the electronic components required for operation of the mirror device 310. To that end, the external module may comprise a width that is slightly less than a width of the cabinet 350 and a depth that is slightly less than a depth of the cabinet 350. In some embodiments, the module may further comprise a height of from about 1 inch to about 6 inches, as desired or required.

The external module 360 may comprise any materials that allow for it to be mounted within a cabinet 350 while protecting the electronic components contained therein from moisture and dust. For example, the external module may be waterproof and may comprise one or more materials selected from the group consisting of: wood, metal, and/or plastic. In one embodiment, the external module 360 may comprise the same material as that of the housing 332

It will be appreciated that, with the exception of the external module 360 and any electronic components located therein, the illustrated mirror device 310 may be substantially similar to the mirror device 210 of FIG. 2. Accordingly, the mirror device 310 may comprise a mirror 304 attached to a housing 332 that includes a number of electronic components seated therein (e.g., a display, cameras, speakers, microphones, etc.). As discussed above, the mirror device 310 may be attached to the cabinet 350 via any number of hinges 328 or the like.

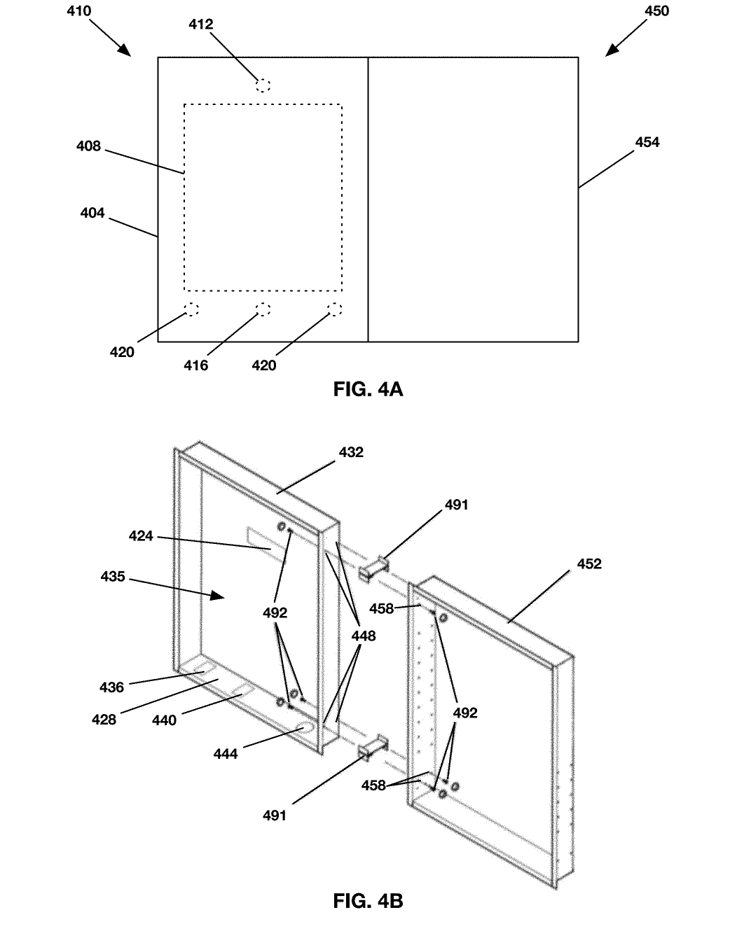

Referring to FIGS. 4A-4B, a mirror with casement embodiment of the interactive mirror device 410 is illustrated. FIG. 4A shows the mirror device 410 next to a traditional mirrored cabinet 450 and FIG. 4B shows how a housing 432 of the mirror device 410 may be connected to a cabinet portion 452 of the mirrored cabinet 450.

The illustrated embodiment of the interactive mirror device 410 allows for the device to be surface mounted to a wall or recess mounted within a wall. Additionally, the illustrated mirror device 410 may be mounted adjacent to, and attached to, a traditional cabinet 450 (e.g., a mirrored medicine cabinet).

As shown in FIG. 4A, the interactive mirror device 410 comprises a mirror 404, a display 408, a camera 412, a microphone 416, one or more speakers 420, a vent 424, a power port 444, input/output ports 436, and a power/reset button 440. Such components may be substantially as described above with respect to FIGS. 2A-2D.

When in use, the electronic components of the mirror device 410 may be disposed within a housing or casement 432, which is adapted to accommodate and protect such components. As shown in FIG. 4B, the housing 432 may comprise a substantially open front surface 435 and substantially flat left, right, top, bottom and back surfaces. The left, right, top, bottom and back surfaces of the housing may be substantially closed (other than vents 424, ports 444, 436, and/or various connection means 448) to prevent ambient light from entering the housing. This may also prevent components disposed within the housing 432 from being seen through a front surface of the mirror 404 when the display 408 is off.

In one embodiment, the open front surface 435 of the housing 432 may include a rim 428 that extends a distance inward from the outer edges of the housing. That is, the front surface 435 of the housing may comprise an aperture having a size/shape that is about equal to the size/shape of the display 408 (i.e., a screen of a display). Accordingly, the front surface 435 may be substantially covered when a display 408 is disposed within the housing and/or when the mirror 404 is attached to the housing.

The housing 432 generally comprises a height and width that are less than or equal to the height and width of the mirror 404. For example, the housing may comprise a height that is equal to about 75 percent to about 98 percent of the height of the mirror 404 (e.g., about 80 percent to about 95 percent); and a width that is equal to about 75 percent to about 98 percent of the width of the mirror (e.g., about 80 percent to about 95 percent). As another example, the height and width of the housing 432 may each be from about 1 inch to about 2 inches less than the height and width of the mirror 404. The housing 432 of the illustrated mirror device embodiment 410 typically comprises a thickness or depth of from about 4 inches to about 8 inches (e.g., about 5 inches). It will be appreciated that the height, width and/or thickness of the housing 432 may be substantially similar to the height, width and/or thickness of a traditional cabinet housing 452 to which the mirror device is, or will be, adjacently mounted and/or connected.

The housing 432 may comprise one or more materials selected from the group consisting of: wood, metal, and/or plastic. And the housing 432 may include one or more edge treatments (e.g., aluminum edge treatments) for aesthetic purposes. The edge treatment may match that of a traditional cabinet to which the interactive mirror device 410 is, or will be, adjacently mounted and/or connected.

The housing 432 may further comprise connecting holes 448 or another element on one or both side surfaces thereof to allow the mirror device 410 to be attached to another mirror device or a traditional cabinet 450 (e.g., using one or more connector pieces). For example, the housing 432 of the interactive mirror device 410 may be attached to a housing 452 of the cabinet 450 by inserting screws 492 into one or more holes 438, 458 of such housings in order to secure a connecting piece 491 therebetween. In one embodiment, two connecting pieces 491 may be employed, and two screws 492 may be used to connect each of the connecting pieces 491.

Although a specific configuration of the mirror device 410 and cabinet 450 is shown in FIGS. 4A-4B, it will be appreciated that any number of alternative configurations are possible. For example, the mirror device 410 may be mounted to the right of the cabinet 450; a second mirror device (not shown) may be mounted on a left side of the cabinet 450; and/or a second mirror device may be mounted to the mirror device 410.

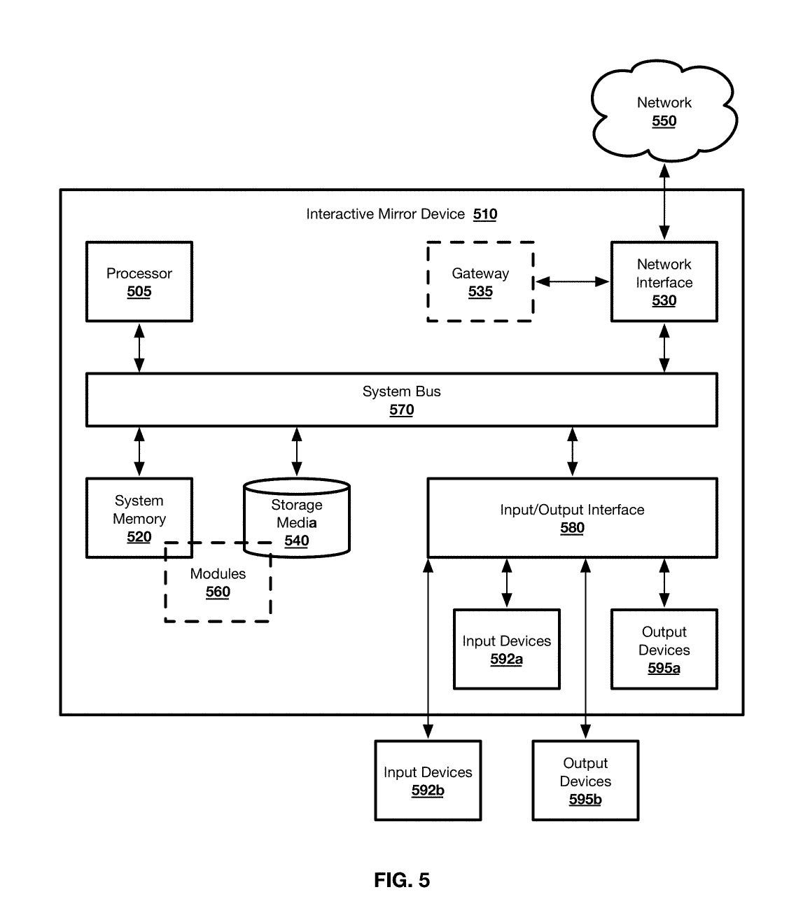

Referring to FIG. 5, exemplary electronic components of an interactive mirror device 510 according to an embodiment are illustrated. As shown, the mirror device 510 may comprise a processor 505, a system bus 570, system memory 520, storage media 540, an input/output interface 580, and a network interface 530 for communicating with a network 550.

Generally, the processor 505 may be configured to execute code or instructions to perform the operations and functionality described herein, manage request flow and address mappings, and to perform calculations and generate commands. The processor 505 may be configured to monitor and control the operation of the components in the mirror device 510. The processor 505 may be a general-purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 505 may be a single processing unit, multiple processing units, a single processing core, multiple processing cores, special purpose processing cores, coprocessors, or any combination thereof. In addition to hardware, exemplary apparatuses may comprise code that creates an execution environment for the computer program (e.g., code that constitutes one or more of: processor firmware, a protocol stack, a database management system, an operating system, and a combination thereof).

The processor 505 may be connected to the other elements of the mirror device 510 or the various peripherals discussed herein through the system bus 570. It will be appreciated that the system bus 570 may be within the processor 505, outside the processor, or both. According to some embodiments, any of the processor 505, the other electronic components of the mirror device 510, or the various peripherals discussed herein may be integrated into a single device such as a system on chip (“SOC”), system on package (“SOP”), or ASIC device.

The system memory 520 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 520 also may include volatile memories, such as random-access memory (“RAM”), static random-access memory (“SRAM”), dynamic random-access memory (“DRAM”), and synchronous dynamic random-access memory (“SDRAM”). Other types of RAM also may be used to implement the system memory. The system memory 520 may be implemented using a single memory module or multiple memory modules. While the system memory 520 is depicted as being part of the mirror device 510, one skilled in the art will recognize that the system memory may be separate therefrom without departing from the scope of the subject technology. It should also be appreciated that the system memory 520 may include, or operate in conjunction with, a non-volatile storage device such as the storage media 540.

The storage media 540 may include a hard disk, a flash memory, other non-volatile memory device, a solid-state drive (“SSD”), any magnetic storage device, any optical storage device, any electrical storage device, any semiconductor storage device, any physical-based storage device, any other data storage device, or any combination or multiplicity thereof. The storage media 540 may store one or more operating systems, application programs and program modules such as module, data, or any other information. The storage media 540 may be part of, or connected to, the mirror device 510. The storage media may also be part of one or more other computing machines that are in communication with the mirror device 510, such as servers, database servers, cloud storage, network attached storage, and so forth.

The modules 560 may comprise one or more hardware or software elements configured to facilitate the mirror device 510 with performing the various methods and processing functions presented herein. The modules 560 may include one or more sequences of instructions stored as software or firmware in association with the system memory 520, the storage media 540, or both. The storage media 540 may therefore represent examples of machine or computer readable media on which instructions or code may be stored for execution by the processor. Machine or computer readable media may generally refer to any medium or media used to provide instructions to the processor. Such machine or computer readable media associated with the modules may comprise a computer software product (e.g., a mirror application). It should be appreciated that a computer software product comprising the modules may also be associated with one or more processes or methods for delivering the module to the mirror device 510 via the network, any signal-bearing medium, or any other communication or delivery technology. The modules 560 may also comprise hardware circuits or information for configuring hardware circuits such as microcode or configuration information for an FPGA or other PLD.

The input/output (“I/O”) interface 580 may be configured to communicate with one or more peripheral devices in order to transmit/receive data to/from the one or more peripheral devices. It will be understood that peripheral devices includes both external devices (e.g., input devices 592b and output devices 595b) and internal device (e.g., input devices 592a and output devices 595a).

In certain embodiments, the I/O interface 580 may include both electrical and physical connections for operably coupling the various peripheral devices to the mirror device 510 or the processor 505. The I/O interface 580 may be configured to communicate data, addresses, and control signals between the peripheral devices, the mirror device 510 or the processor 505. The I/O interface 580 may be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attachment (“ATA”), serial ATA (“SATA”), USB, Thunderbolt, FireWire, various video buses, and the like. The I/O interface may be configured to implement only one interface or bus technology, or may be configured to implement multiple interfaces or bus technologies. The I/O interface may be configured as part of, all of, or to operate in conjunction with, the system bus 570. In some embodiments, the I/O interface 580 may include one or more buffers for buffering transmissions between one or more external devices 592b, 595b, internal devices 592a, 595a, the mirror device 510, or the processor 505.

The I/O interface 580 may couple the mirror device 510 to various internal input devices 592a and/or external input devices 592b (collectively referred to as input devices 592). Exemplary input device 592 may include, but are not limited to: touchscreens, pointing device, keyboards, cameras, microphones, scanners, biometric readers, electronic digitizers, motion sensors, proximity sensors, environmental sensors (e.g., humidity sensors, temperature sensors and the like), receivers, actuators (e.g., a power/reset button, a light switch, a fan switch, etc.) and/or any combinations thereof. When coupled to the mirror device, such input devices 592 may receive input from a user in any form, including acoustic input, visual input or tactile input. Additionally or alternatively, connected input devices 592 may receive input from an environment (e.g., temperature, light, moisture, etc.) and/or from other electronic components.

In one embodiment, the mirror device 510 may be configured to store and analyze images recorded by one or more internal or external cameras. For example, upon receiving one or more images of a user, the mirror device may employ facial recognition processing to identify the user. As another example, the mirror device 510 may analyze received images to detect one or more predetermined user gestures that may be employed to control a mirror application. And, as yet another example, the mirror device may analyze received images to measure or determine various information about a particular user (e.g., heart rate, body composition, emotional state, respiratory rate, complexion, hair style, clothing, and/or other characteristics).

In another embodiment, the mirror device 510 may be configured to store and analyze audio information recorded by one or more internal or external microphones. For example, upon receiving audio information from a user, the mirror device may employ voice recognition technology to identify the user. As another example, the mirror device 510 may analyze received audio information to detect one or more predetermined voice commands that may be employed to control a mirror application.

The mirror device 510 typically includes one or more power/reset buttons that allow a user to power the mirror device on/off and execute a system reset function. In certain embodiments, the mirror device may be configured to automatically “wake up” from a sleep mode upon actuation of the power button or upon detection of certain types of audio information (e.g., voice commands) and/or visual information (e.g., user gestures or motion).

The I/O interface 580 may also couple the mirror device 510 to various internal output devices 595a and/or external output devices 595b (collectively referred to as output devices 595). Exemplary output devices 595 may include, but are not limited to: displays, speakers, actuators, motors (e.g., vibration motors to provide tactile feedback), fans, lights, transmitters, signal emitters, and so forth. When coupled to the mirror device, such output devices 595 may transmit output or feedback to a user in any form, including acoustic feedback, visual feedback and/or tactile feedback. Additionally or alternatively, connected output devices 595 may transmit feedback to other electronic components of the mirror device 501.

As discussed above, the mirror device 510 comprises one or more displays. Exemplary displays include, but are not limited to: projectors, cathode ray tube (“CRT”) monitors, liquid crystal displays (“LCD”), light-emitting diode (“LED”) monitors and/or organic light-emitting diode (“OLED”) monitors. The display is arranged to be visible through a mirror of the interactive mirror device 510 when it is in a powered state and not visible when in an unpowered state. In certain embodiments, the display may be placed in communication with an input device (e.g., a touchscreen) to enable a user to control the mirror application via tactile commands. A touchscreen input may be attached to, or incorporated into, the display.

The mirror device 510 may also comprise one or more speakers such that the device may transmit auditory feedback to a user. Exemplary auditory feedback may include playing files comprising audio information (e.g., music files, video files, etc.) and/or transmitting natural language responses to any user input (e.g., via voice assistant features).

It will be appreciated that, in addition to providing feedback to a user via an output device 595, the mirror device 510 may transmit feedback to a user device associated with the user. For example, the mirror device may receive a request for information from a user (e.g., via an input device such as a microphone) and, in response, the mirror device may transmit a notification or file containing the requested information to a client application running on the user device.

In some embodiments, the output devices 595 may comprise a fan to regulate temperature and/or humidity within a housing of the mirror device 510. The fan may be automatically controlled by the mirror device 510 and/or may be manually controlled by a separate input device 592, such as a switch. For example, the mirror device may be configured to control the fan (e.g., via power regulation circuitry) based on information received from one or more temperature and/or humidity sensors.

Embodiments of the interactive mirror device 510 may be associated with one or more of the following components: a backend component (e.g., a data server); a middleware component (e.g., an application server); a frontend component (e.g., a graphical user interface (“GUI”) through which a user can interact with mirror application); and/or combinations thereof. The components of the system can be interconnected by any form or medium of digital data communication, such as but not limited to, a communication network.

Accordingly, the mirror device 510 may operate in a networked environment using logical connections through a network interface 530 to one or more other systems or computing machines across a network 550. The network 550 may include wide area networks (“WAN”), local area networks (“LAN”), intranets, the Internet, wireless access networks, wired networks, mobile networks, telephone networks, optical networks, or combinations thereof. The network 550 may be packet switched, circuit switched, of any topology, and may use any communication protocol (e.g., BLE, NFC, RFID, LR-WPAN, WIFI, infrared, cellular, Ethernet, USB, FireWire, Thunderbolt, etc.). Communication links within the network 550 may involve various digital or an analog communication media such as fiber optic cables, free-space optics, waveguides, electrical conductors, wireless links, antennas, radio-frequency communications, and so forth.

In one embodiment, the mirror device 510 may comprise one or more internal IoT gateways 535 in communication with or integrated into the network interface 530. As discussed above, an IoT gateway 535 may be adapted to communicate with one or more IoT devices using a first communication protocol (e.g., ZIGBEE) and with one or more other devices in a second protocol (e.g., Ethernet or WIFI). In some embodiments, the IoT gateway 535 may additionally or alternatively comprise a wireless network range extender or repeater.

Referring to FIG. 6, an exemplary dashboard screen 600 of a mirror application running on a mirror device 610 is illustrated. The dashboard screen 600 is displayed to a user via a display 608 mounted behind a mirror 604 of a mirror device 610.

As shown, the dashboard screen 600 displays various components of the mirror application, including applications (“apps”) 630, widgets 620, notifications 640 and voice assistant functionality 650. The mirror application may utilize such components to receive and display information to/from connected devices/services, such as a server, admin devices, IoT devices, user devices and one or more third-party systems. The interface components may display such information automatically (e.g., continuously or at predefined intervals) or in response to a query from a user of the interactive mirror device.

In certain embodiments, the mirror application (including any installed apps 630) may perform additional processing steps relating to received or stored information in order to calculate, transmit and/or display additional information, such as personalized recommendations and suggestions. To that end, the mirror application (or the server) may implement machine learning algorithms or similar techniques to iteratively and/or continuously calculate information from received/stored information and update such calculated information. With increased use, the system may determine and/or store various statistics associated with a user's activities and such information may be employed to improve calculated information over time.

In certain embodiments, the system may store, retrieve, and/or analyze data from internal and connected systems using a machine learning engine that employs one or more of the following machine learning algorithms: Logistic Regression, Decision Tree Learning, Bayesian Networks, Random Forests, Support Vector Machine and/or Artificial Neural Networks. It will be appreciated that various machine learning algorithms provide different results for different types of data structured or unstructured, text, documents, geolocation, images, etc. Also, data may vary among users and/or groups of users. Accordingly, the system may test training data and validate a plurality of algorithms to select the most effective for a particular data set and/or user(s).

As shown in FIG. 6, the dashboard screen 600 may display a plurality of apps 630, where each app is represented by a selectable icon or link. In one embodiment, the mirror application may be configured to enable a user to select, purchase, download and/or install such apps via an installation option 657. Additionally or alternatively, apps may be installed on the mirror device by an admin user.

Once installed, each app may be executed by the mirror device 610 in order to display received and/or calculated information via various user interface elements. The apps may also receive any type of user input (voice, images, gestures, touch, etc.) to allow users to interact with displayed information. For example, an app may be configured to receive touch input to allow a user to swipe through displayed information time or type. As another example, an app may be configured to receive visual gesture input to allow a user to overlap and compare displayed data sets to determine correlations and patterns.

As shown, the mirror application may include any number of installed apps. Exemplary apps may include, but are not limited to: calendar apps 631, news and weather apps 632, community apps 633, IoT devices apps 634, health and fitness apps 635, email and communications apps 636 (e.g., social networking and messaging apps), beauty and fashion apps 637, navigation and mapping apps 638, media playback and editing apps, apps relating to any number of services 639, productivity and business apps, logistics apps (e.g., shipping services, scheduling services, etc.), sports and entertainment apps, food-related apps (e.g., delivery, reservations, etc.), and/or user review apps.

In one embodiment, the mirror application may include a devices app 634 to allow the user to configure any of the connected devices. The devices app 634 (and/or a separate client application) may enable a user to setup automated routines, where connected devices are controlled by the mirror device, based on the time or information received from a connected device or service. For example, connected window shades may be configured to rise at 6:00 am and fall after all residents have left a residence, as may be detected by motion sensors in the residence. Additionally or alternatively, the mirror application may automatically configure any of the connected devices based on calculated information.

The mirror application may also include a maps and navigation app 638. This app may be configured to receive, determine and display travel information relating to predetermined and queried locations (e.g., “home” and “work”). In one embodiment, the app may provide information relating to commute times, suggested routes between locations, traffic patterns, road closures, public transit locations, public transit availability and delays, car services, various transportation rental services (e.g., cars, bikes, scooters) and other travel information.

It will be appreciated that the maps and navigation app 638, like many of the above-listed apps, may be connected to other apps to allow information to be shared across the system. As a specific example, the maps and navigation app 638 may be connected to a calendar app 631 such that, when the user's calendar includes an event to which the user must drive, the calendar app may display a notification to suggest a driving route based on current or anticipated traffic patterns. Accordingly, communication among apps may provide for improved suggestions and recommendations across the system.

In one embodiment, the mirror application may include a health and fitness app 635. This app may be adapted to connect to various health and fitness IoT devices and systems in order to aggregate and a user's health information. For example, the app 635 may display any of the following information for a predetermined or user-selected time period: an aggregate workout time, workout details, total steps, total calories consumed, total calories burned, resting heart rate, weight, sleep activity, meditation activity, water intake, a wellness goal, and progress towards the wellness goal.

The health and fitness app 635 may also determine and display various suggestions and recommendations. For example, the app may employ current and/or historical health, wellness and/or fitness information received from one or more devices associated with a user to determine and display a customized workout routine or schedule for the user.

As another example, the app 635 may determine a workout-specific music playlist for the suggested workout routine, based on current and/or historical music information received from one or more devices associated with the user. Depending on user preferences, the app may automatically load the playlist onto a preferred music listening device associated with the user or may display an option 657 to allow the user to manually load the playlist onto one or more music listening devices.

As yet another example, the health and fitness app 635 may determine, based on historical user information, that the user typically works out at particular times on certain days of the week. Upon such determination, the app may cause a notification 644 relating to the suggested workout time to be displayed to the user.

In one embodiment, the mirror application may include a media app 663 that enables users to view or listen to audio files, video files and/or image files. In one embodiment, the media app 663 may employ user information to automatically determine entertainment suggestions for the user relating. Exemplary entertainment suggestions may relate to music or video playlist for a scheduled or suggested activity.

Finally, the mirror application may include any number of services apps 639, which may be adapted to provide suggested services, locations, events and/or purchases. For example, a services app may provide restaurant suggestions based on previous restaurants visited by the user, user financial information, and/or user reviews. As another example, a services app may provide product purchase suggestions, which may be based on prior purchases and other user information.

As shown, the dashboard screen 600 may also include a number of widgets 620, such a weather widget 622 and a time widget 621. Generally, each widget may be associated with a corresponding app, and may be adapted to display information received or determined by such app. For example, a weather widget 622 may be associated with a news and weather app 632 such that it may display an image or animation corresponding to the current local weather conditions. As another example, a media player widget 623 may be associated with a media app 663 such that it may display information about a song that is currently playing and various user options relating thereto (e.g., play, pause, volume, skip, etc.).

The dashboard screen 600 may also include a notifications section 640, which displays various notifications 641-644. Generally, each displayed notification may include information received from one or more connected devices/systems and information calculated by the mirror application (including any installed apps).

The notifications may also include one or more options to allow the user to take various action relating to the notification. For example, an option 642 to open an email may be included with a new email notification 641; an option 646 to turn off a smart oven may be included with a food-status notification 645; an option 653 to view package information may be included with a new package notification 643; and an option 657 to view, edit or sync an automatically generated playlist may be displayed with a health notification 644.

In certain embodiments, the dashboard screen 600 may include a voice assistant feature 650. This feature may analyze received audio information to detect one or more predetermined voice commands. Such voice commands may be employed to control various aspects of the mirror application, such as parameters of input and output devices (e.g., on/off, volume, etc.) The voice commands may also allow the user to request information from the voice assistant and/or interact with any of the apps 630, widgets 620, and/or notification 640.

In one embodiment, the voice assistant feature 640 provides voice recognition functionality to allow identification and authentication of any number of users. In another embodiment, the voice assistant feature 640 may be adapted to transmit auditory feedback to a user. For example, the voice assistant may provide a natural language response to any user input.

As shown, the dashboard screen 600 may include a user profile option 624, which allows a user to: view a user profile stored by the device 610 or a server/database connected thereto, modify any user information associated with the profile, and/or switch from a first user profile to a second user profile (e.g., based on the current user of the mirror device). It will be appreciated that the mirror application may support multiple user profiles and may distinguish among users based on one or more authentication techniques, such as a spoken or inputted username/password, voice recognition, facial recognition, and/or proximity of a particular user device adapted to store and transmit authentication information (e.g., a token) to the mirror device.

In one embodiment, the dashboard screen 600 may also include a settings option 612, which allows a user to access one or more application settings, such as display settings, app settings, privacy settings, etc. As an example, display settings may include options relating to brightness, contrast, color, and others. As another example, privacy settings may include options to turn off one or more input devices (e.g., a camera or microphone), output device (e.g., speakers) and/or network connections.

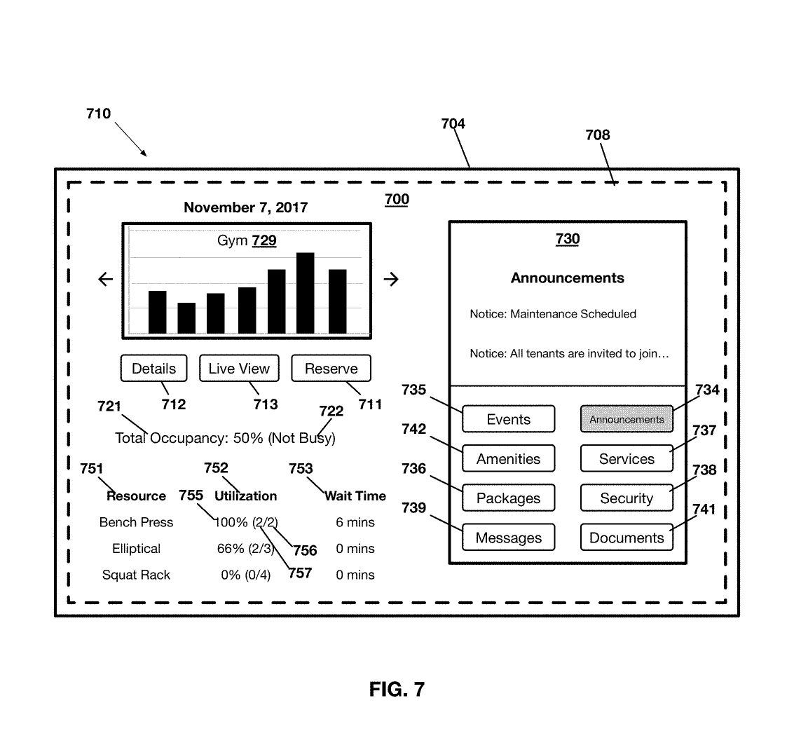

Referring to FIG. 7, an exemplary community app screen 700 of a mirror application running on a mirror device 710 is illustrated. The screen 700 is displayed to a user via a display 708 mounted behind a mirror 704 of a mirror device 710.

In certain embodiments, the mirror device 710 may be employed by managers or leaders of a community to provide relevant information to community members. As used herein, a “community” refers to a group of people who share one or more common interests relating to a location in which any number of mirror devices are deployed. Communities may include, but are not limited to, residents of a building, employees who work in an office, students who attend a school, shoppers located in a mall, travelers located in an airport, and many others.

As an example, a manager of an apartment building, may install mirror devices 710 in any number of apartments and/or any number of central locations (e.g., a lobby, a hallway, a gym, etc.) throughout the building. In such case, each of the mirror devices 710 may be placed in communication with a central community system via a network and each of the mirror devices may include a preinstalled community app to receive/transmit community information from/to the community system. Accordingly, the manager may send useful community information to the building's residents and/or staff via the installed mirror devices 710.

As shown in FIG. 7, the community app screen 700 may display community information 730, such as information relating to building announcements 734, upcoming social events and meetings 735, mail and package deliveries and pickups 736, available services 737, security 738 (e.g., visitor authorization), personal messages from other community members and managers 739, financial and legal documents 741, and amenities 742.

In some embodiments the community app may allow users to take any number of actions relating to community information. For example, the app may allow users to schedule community events; send messages to one or more community managers or members; request, schedule and/or purchase available services; execute rental agreements and other legal documents; and/or view and pay bills. As shown in FIG. 6, notifications 643 relating to any of such community information and/or related actions 643 may also be displayed via the mirror application dashboard 600.

In one embodiment, the community app screen 700 may display occupancy and/or utilization information 729 relating to shared amenities and various resources or assets associated with such amenities. Exemplary amenities may include gyms, spas and other wellness facilities; conference rooms and business centers; restaurants, bars and outdoor space; game rooms, lounges and child playrooms; cooking facilities; and many others. And exemplary resources associated with amenities may include gym equipment, furniture and office equipment (e.g., desks, office supplies, etc.), areas within a physical space (e.g., a private area of a rooftop), entertainment equipment (e.g., televisions, game systems, etc.), cooking equipment (e.g., grills, kitchen utensils, etc.) and others.

Generally, the mirror device 710 may receive amenity occupancy information and resource utilization information from the server, which may be connected to any number of third-party amenity occupancy and utilization systems (“AOU” systems) via a network. The AOU systems may be adapted to employ object recognition, definition and tracking functionality. Accordingly, each AOU system comprise a plurality of cameras adapted to receive images relating to amenities to be monitored. In some embodiments, the AOU systems may employ additional sensors, such as Bluetooth sensors, Near-Field Communication sensors, Bluetooth Low Energy Sensors, WIFI transceivers, microphones, and others.

In one embodiment, the system may employ some or all of the following information to recognize, define and track amenity occupation and resource utilization information: shape, size, position, location, movement, and/or or other sensed/recorded factors relating to a person and/or a resource. Additionally, the system may determine and employ information relating to changes in size, shape, position, absolute location and/or relative location (i.e., proximity) of the person and/or resource. Such information may be determined and delivered to the server and/or a separate control system for storage and further analysis.

Based on a wide variety of possible object and activity recognition, definition and tracking algorithms, the system may determine that a resource is being used by a person. The system may also determine the resource's type, a specific resource being used and, optionally, an identity of the person using the resource, based on such information and a corresponding library of profile data for each such factor recorded.

It will be appreciated that the object and/or activity recognition functionality of the system may be improved by manually adjusting library factors recorded for a given object or activity. Additionally or alternatively such recognition functionality may be improved via supervised or semi-supervised training techniques that employ test data to automatically adjust such library factors.

As shown in FIG. 7, in one embodiment, the screen 700 may display real-time and/or historical occupancy information determined for a given amenity. For example, the screen may display current total occupancy 721 for an amenity, and/or historical or projected hourly occupancy 729 for the amenity (e.g., in the form of a chart or graph).

In some embodiments, the displayed occupancy information may be based on a predefined maximum allowable occupancy for a given amenity. For example, the system may compare the number of current occupants to the predetermined maximum and display the results 721. As another example, the system may compare the number of current occupants to an average or median number of occupants over a given historical time period to determine and display a “businesses” classification 722 (e.g., “very busy,” “busy,” “average,” “not busy” and/or “empty”). In certain embodiments, such classification may be determined, in part, based on comparing (1) user feedback relating to users' perceptions of how busy a particular amenity was at a given time to (2) a determined total occupancy of the amenity at the given time.

The screen 700 may also show real-time and/or historical utilization information 752 relating to any number of resources 751 associated with a given amenity. For example, the screen may display a name and/or description of each resource 751, a total number of each resource associated with the amenity 756, and a number 757 or percentage 755 of each resource that is currently in use. In one embodiment, the system may display a projected wait time 753 relating to an amount of time until at least one of the resource will be available. The system may determine a projected wait time based on any stored, historical, resource-specific utilization information.

In certain embodiments, the screen 700 may allow a user to take one or more actions relating to displayed amenities and/or resources associated therewith. For example, the app may display an option 712 to view amenity information relating to a given amenity (e.g., name, description, images, etc.) and/or resource utilization details relating to one or more resources associated with the amenity. As another example, the app may display an option 713 to view one or more live camera feeds relating to a given amenity and/or associated resources. And, as another example, the app may display an option 711 to reserve a resource associated with the selected amenity.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory program carrier for execution by, or to control the operation of, data processing apparatus (i.e., one or more computer programs). Program instructions may be, alternatively or additionally, encoded on an artificially generated propagated signal (e.g., a machine-generated electrical, optical, or electromagnetic signal) that is generated to encode information for transmission to suitable receiver apparatus for execution by a data processing apparatus. And the computer storage medium can be one or more of: a machine-readable storage device, a machine-readable storage substrate, a random or serial access memory device, and combinations thereof.

As used herein, the term “data processing apparatus” comprises all kinds of apparatuses, devices, and machines for processing data, including but not limited to, a programmable processor, a computer, and/or multiple processors or computers. Exemplary apparatuses may include special purpose logic circuitry, such as a FPGA and/or an ASIC. In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code). A computer program can be deployed and/or executed on one computer or on multiple computers that are located at one site or distributed across multiple sites and interconnected by a communication network.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A system comprising:
a server storing user information associated with a user;
a mirror device in communication with the server via a network, the mirror device comprising:
a housing comprising:
front panel having an aperture therein;
a back panel comprising an input port located therein; and
left, right, top, and bottom panels extending from the front panel to the back panel to define an inner chamber;
electronic components disposed within the inner chamber of the housing, the electronic components comprising:
a network interface receiving the user information from the server via the network;
a memory storing the received user information;
an input device receiving a user request from the user;
a processor in communication with the memory, the input the device, and the network interface, the processor determining a recommendation for the user based on the user information and the user request; and
a display in communication with the processor, the display displaying the determined recommendation; and
a mirror comprising:
a front surface;
a back surface attached to the front panel of the housing; and
top, bottom, left and right surfaces extending form the front surface to the back surface.

2. A system according to claim 1 further comprising:
an external module comprising:
an input power port located on an outer surface of the external module,
wherein the input power port is in electrical communication with a power source; and
an output power port located on the outer surface,
wherein the output power port is in electrical communication with the input port of the mirror device.

3. A system according to claim 2 further comprising a cabinet having an open front face, wherein:
the mirror device is attached to the cabinet;
the back panel of the housing of the mirror device entirely covers the open front face of the cabinet when the mirror device is in a first position; and
the back panel does not entirely cover the open front face of the cabinet when the mirror device is in a second position.

4. A system according to claim 3, wherein the external module is disposed entirely within the cabinet.

5. A system according to claim 1 further comprising:
an Internet of Things (“IoT”) device in communication with the mirror device, the IoT device storing second user information relating to the user in a memory thereof,
wherein the mirror device receives the second user information, and
wherein the said determining the recommendation is further based on the second user information.

6. A system according to claim 5, wherein the IoT device comprises one or more of: a health device, a home automation device and an environmental sensing device.

7. A system according to claim 6, wherein:
the IoT device is a health device; and
the second user information comprises health information selected from the group consisting of: physical activity information, sleep information, meditation information, medical information and nutritional information.

8. A system according to claim 5 further comprising a gateway, and wherein:
the gateway is in communication with the network interface of the mirror device via the network; and
the gateway is in communication with the IoT device via a second network.

9. A system according to claim 1 further comprising a user device associated with the user, and wherein:
the mirror device receives configuration information from the user device, and
said determining the recommendation is further based on the configuration information.

10. A system according to claim 9, wherein the mirror device transmits the recommendation to the user device.

11. A system according to claim 1, wherein the input device comprises a camera or a microphone.

12. An interactive mirror device comprising:
a housing comprising:
a front panel having an aperture therein;
a back panel; and
left, right, top, and bottom panels extending from the front panel to the back panel to define an inner chamber;
a plurality of electronic components disposed within the inner chamber of the housing, the electronic components comprising:
a processor;
a memory in communication with the processor;
an input device in communication with the processor;
an output device in communication with the processor;
a network interface in communication with the processor; and
a display in communication with the processor, the display comprising a screen,
wherein the display is positioned within the inner chamber of the housing such that the screen faces the front panel and substantially covers the aperture; and
a mirror comprising:
a front surface;
a back surface; and
top, bottom, left and right surfaces extending form the front surface to the back surface,
wherein the back surface of the mirror is attached to the front panel of the housing such that the back surface of the mirror completely covers the front panel of the housing and the screen of the display,
wherein the mirror device is configured to allow images displayed on the screen to show through the front surface of the mirror when the display is on, and
wherein the mirror device is further configured to prevent the screen from being seen through the front surface of the mirror when the display is off.

13. A mirror device according to claim 12, wherein the housing comprises a vent located on one or more of the panels.

14. A mirror device according to claim 12, wherein the housing comprises a thickness of from about 0.5 inches to about 1.5 inches.

15. A mirror device according to claim 12, wherein the display comprises a touchscreen.

16. A mirror device according to claim 15, wherein the touchscreen comprises a projected capacitive touch (“PCT”) touchscreen.

17. A mirror device according to claim 12, wherein the input device comprises one or both of a microphone and a camera.

18. A mirror device according to claim 12, wherein the output device comprises one or more of a speaker, a vibration motor and a light.

19. A mirror device according to claim 12, wherein the back surface of the mirror comprises one or more aluminum strips adhered thereto.

20. A mirror device according to claim 12 wherein the front surface of the mirror is coated with one or more coatings selected from the group consisting of: a reflective coating, a dielectric coating, a transparent conductive coating, an anti-fingerprint oleophobic coating, an anti-fog coating and an anti-bacterial coating.
